(19) United States
(12) Patent Application Publication
(10) Pub. No.: US 2025/0296821 A1
(43) Pub. Date: Sep. 25, 2025

(54) LIFT ASSEMBLY

(71) Applicant: Herkules Equipment Corporation, Walled Lake, MI (US)

(72) Inventors: Todd John Bacon, Northville, MI (US); Eliana Virginia Podolski Bacon, Northville, MI (US); Scott Francis Wilhelm, Brighton, MI (US); Leigh Nelson Gaither, Taylor, MI (US)

(21) Appl. No.: 19/084,231

(22) Filed: Mar. 19, 2025

Related U.S. Application Data
(60) Provisional application No. 63/567,583, filed on Mar. 20, 2024.

(51) Int. Cl. B66F 3/22; B66F 3/44; B66F 7/12

(52) U.S. Cl. CPC B66F 3/22; B66F 3/44; B66F 7/12

(57) ABSTRACT

A lift assembly having a base, a platform moveable relative to the base between a raised position and a lowered position, and a scissor mechanism coupled to the base and to the platform to move the platform relative to the base. The scissor mechanism includes a first arm, a second arm, a third arm, and a fourth arm supported by the base and extending toward the platform. The first and second arms, as well as the third and fourth arms, are pivotable relative to one another to define a pair of scissor arms to assist the platform in moving between the raised position and the lowered position. A drive mechanism is disposed between the pairs of scissor arms to move the platform between the raised position and the lowered position. The drive mechanism includes a carriage coupled to the base such that the drive mechanism is moveable relative to the base.

### CROSS-REFERENCE TO RELATED APPLICATIONS

This application claims priority to and all the benefits of U.S. Provisional Application No. 63/567,583, filed Mar. 20, 2024, which is hereby incorporated by reference in its entirety.

### BACKGROUND OF THE INVENTION

### 1. Field of the Invention

The invention generally relates to a lift assembly.

### 2. Description of the Related Art

Lift assemblies commonly include a base, a platform moveable relative to the base, a first pair of scissor arms, and a second pair of scissor arms. The first pair of scissor arms and the second pair of scissor arms typically pivot to permit the platform to move. Movement of the scissor arms, and thus the platform, is typically effectuated by a drive assembly. Conventionally, these drive assemblies are fixed relative to the base. However, because conventional drive assemblies are fixed to the base, the first and second pairs of scissor arms must be arranged to limit physical interference with the drive assembly as the platform moves to a lowered position. Typically, such physical interference prevents the platform from being lowered to a sufficient height for many applications.

As such, there remains a need for an improved lift assembly.

### SUMMARY OF THE INVENTION AND ADVANTAGES

The present invention provides a lift assembly including a base, a platform moveable relative to the base between a raised position and a lowered position, and a scissor mechanism coupled to the base and to the platform to move the platform relative to the base. The scissor mechanism includes a first arm, a second arm, a third arm, and a fourth arm supported by the base and extending toward the platform. The first arm and the second arm are pivotable relative to one another to define a first pair of scissor arms to assist the platform in moving between the raised position and the lowered position. The third arm and the fourth arm are pivotable relative to one another to define a second pair of scissor arms to assist the platform in moving between the raised position and the lowered position. A drive mechanism is disposed between the first and second pair of scissor arms to move the platform between the raised position and the lowered position. The drive mechanism includes a carriage coupled to the base such that the drive mechanism is moveable relative to the base with at least one of the first arm, the second arm, the third arm, and the fourth arm during the movement of the platform between the raised and lowered positions.

Accordingly, the drive mechanism is able to move the platform between the raised position and the lowered position without unnecessary intervening components. There has thus been outlined, rather broadly, certain features of embodiments of the invention in order that the detailed descriptions thereof may be better understood, and in order that the present contribution to the art may be better appreciated. Additional or alternative features of embodiments of the invention are described in further detail below.

In this respect, before explaining embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

To accomplish the above and related objects, the invention may be embodied in the forms illustrated in the accompanying drawings, attention being called to the fact, however, that the drawings are illustrative only, and that changes may be made in the specific constructions illustrated. Moreover, it is to be noted that the accompanying drawings are not necessarily drawn to scale or to the same scale. In particular, the scale of some of the elements of the drawings may be exaggerated to emphasize characteristics of the elements.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a lift assembly in a raised position;

FIG. 2 is a perspective view of the lift assembly in a lowered position;

FIG. 3 is a perspective view of the lift assembly in the lowered position, with a platform of the lift assembly removed;

FIG. 4 is another perspective view of the lift assembly in the raised position;

FIG. 5A is an enlarged perspective view of the lift assembly in the raised position;

FIG. 5B is an enlarged perspective view of another embodiment of the lift assembly in the raised position;

FIG. 6 is a cross-sectional view of the lift assembly in the lowered position, with the platform of the lift assembly removed;

FIG. 7 is a side view of the lift assembly in the raised position;

FIG. 8 is a side view of the lift assembly in the lowered position; and

FIG. 9 is a cross-sectional view of the lift assembly in the lowered position of FIG. 8.

While the invention is susceptible to various modifications and alternative forms, specific embodiments thereof are shown by way of example in the drawings and may herein be described in detail. It should be understood, however, that the drawings and detailed description thereto are not intended to limit the invention to the particular forms disclosed, but on the contrary, the intention is to cover all modifications, equivalents and alternatives falling within the spirit and scope of the present invention as defined by the appended claims.

### DETAILED DESCRIPTION OF THE INVENTION

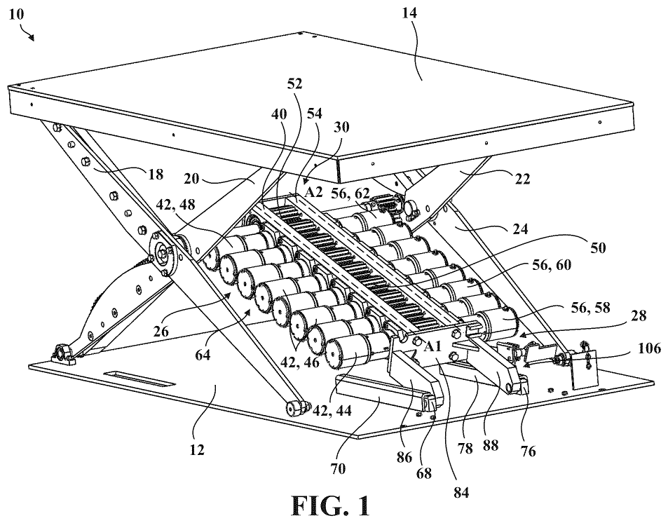

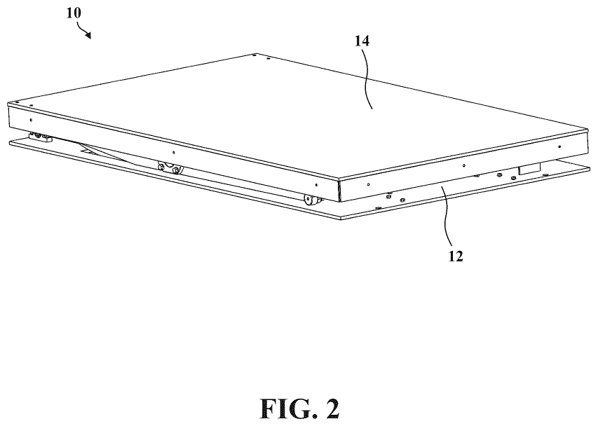

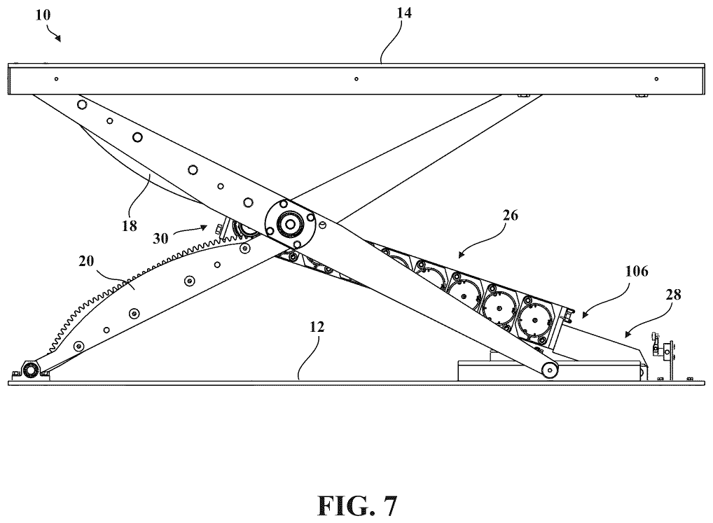

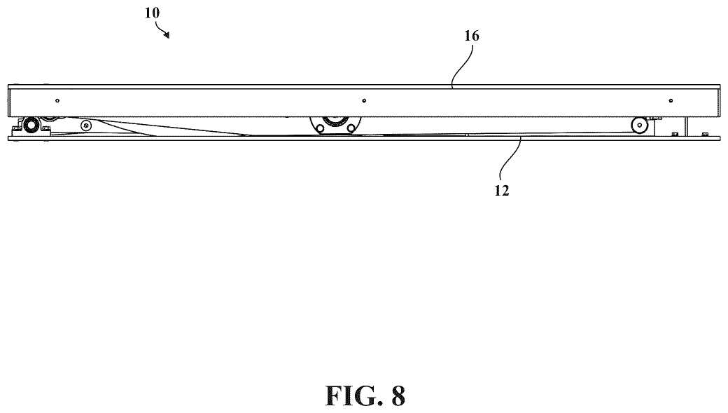

With reference to the Figures, wherein like numerals indicate like parts throughout the several views, a lift assembly 10 is provided. The lift assembly 10 includes a base 12 and a platform 14 moveable relative to the base 12 between a raised position, as shown in FIGS. 1, 4, and 7, and a lowered position, as shown in FIGS. 2, 3, 6, 8, and 9. The lift assembly 10 also includes a scissor mechanism 16 coupled to the base 12 and to the platform 14 to move the platform 14 relative to the base 12. The scissor mechanism 16 includes a first arm 18 supported by the base 12 and extending toward the platform 14 and a second arm 20 supported by the base 12 and extending toward the platform 14. The first arm 18 and the second arm 20 are pivotable relative to one another to define a first pair of scissor arms to assist the platform 14 in moving between the raised position and the lowered position. The scissor mechanism 16 also includes a third arm 22 supported by the base 12 and extending toward the platform 14 and a fourth arm 24 supported by the base 12 and extending toward the platform 14. The third arm 22 and the fourth arm 24 are pivotable relative to one another to define a second pair of scissor arms to assist the platform 14 in moving between the raised position and the lowered position.

The lift assembly 10 also includes a drive mechanism 26 disposed between the first and second pair of scissor arms to move the platform 14 between the raised position and the lowered position. Accordingly, the drive mechanism 26 is able to move the platform 14 between the raised position and the lowered position without unnecessary intervening components. In non-limiting examples, the drive mechanism 26 is able to move the platform 14 between the raised position and the lowered position without a drive belt, a chain, or the like.

The drive mechanism 26 includes a carriage 106 coupled to the base 12 such that the drive mechanism 26 is moveable relative to the base with at least one of the first arm 18, the second arm 20, the third arm 22, and the fourth arm 24 during movement of the platform 14 between the raised and lowered positions. The carriage 106 extends between a first end 28 supported by the base 12 and a second end 30 supported by the second arm 20 of the scissor mechanism 16. The second end 30 of the carriage 106 may also be supported by the first arm 18, the third arm 22, and/or the fourth arm 24 of the scissor mechanism 16. In the embodiment illustrated, the drive mechanism 26 and carriage 106 pivot as a unit at an angle relative to the base 12 as the platform moves between the raised position and lowered position. The first end 28 of the carriage 106 preferably pivots relative to the base 12. As described in further detail herein, the first end 28 of the carriage 106 preferably moves along the base 12 while still being supported by the base 12. As also discussed in greater detail below, the carriage 106 as illustrated is formed of multiple components and moves as a unit. It is to be appreciated that the carriage 106 could be configured differently without deviating from the scope of the invention.

The first arm 18 may be rotationally fixed to the platform 14 and may be moveable relative to the base 12. In a non-limiting example, the first arm 18 may include a first wheel 32 in contact with the base 12 to permit the first arm 18 to move relative to the base 12. The second arm 20 may be rotationally fixed to the base 12 and may be moveable relative to the platform 14. In a non-limiting example, the second arm 20 may include a second wheel 34 in contact with the platform 14 to permit the second arm 20 to move relative to the platform 14. The third arm 22 may be rotationally fixed to the base 12 and may be moveable relative to the platform 14. In a non-limiting example, the third arm 22 may include a third wheel 36 in contact with the platform 14 to permit the third arm 22 to move relative to the platform 14. The fourth arm 24 may be rotationally fixed to the platform 14 and may be moveable relative to the base 12. In a non-limiting example, the fourth arm 24 may include a fourth wheel 38 in contact with the base 12 to permit the fourth arm 24 to move relative to the base 12.

The carriage 106 of the drive mechanism 26 may extend along an axis A1 between the first end 28 and the second end 30. The drive mechanism 26 also includes a mount block 40 extending along the axis A1 and includes a plurality of electric motors 42 supported by the mount block 40. The electric motors 42 may be arranged in series along the axis A1 to define an initial electric motor 44, one or more intermediate electric motors 46, and a final electric motor 48. The drive mechanism 26 also includes a gear 50 mounted to each of the electric motors 42. Thus, the drive mechanism 26 may include a plurality of gears 50. The drive mechanism 26 further includes an output gear 52 driven by the gear 50 mounted to the final electric motor 48 to receive the combined rotational torque from the gears 50 of the series of electric motors 42.

The plurality of electric motors 42 arranged in series permits the rotational torque from the gears 50 to be combined. The combined rotational torque from the gears 50 of the series of electric motors 42 is then transferred from the gear 50 of the final electric motor 48 to drive the output gear 52. The series arrangement of the plurality of electric motors 42 lowers the profile of the drive mechanism 26 while still being capable of generating significant power due to the rotational torque from the gears 50 being combined.

As shown in FIGS. 1, 3, and 9, the plurality of gears 50 may be in meshed relation with one another. In other words, each of the plurality of gears 50 may be in contact with at least one adjacent gear 50. Moreover, the gear 50 of the final electric motor 48 may be in meshed relation with the output gear 52. The plurality of electric motors 42 may each be stepper electric motors. The plurality of electric motors 42 may each include a housing, a stator disposed within the housing, and a rotor disposed within the stator.

In one embodiment, each electric motor 42 is be fixed to the mount block 40. The drive mechanism 26 may further include a plurality of motor shafts rotationally fixed to the rotors of the electric motors 42 and rotationally fixed to one of the plurality of gears 50. In a non-limiting example, each motor shaft may be keyed, or splined, to one of the plurality of gears 50 to rotationally fix the motor shaft to the gear 50. In other non-limiting examples, each motor shaft may be welded, brazed, soldered, or otherwise physically joined with one of the plurality of gears 50, each motor shaft may be integral with one of the plurality of gears 50, or each motor shaft may be formed integrally with one of the plurality of gears 50 such as but not limited to by casting. The motor shaft associated with the electric motor 42 may extend through a bore defined by the mount block 40. As such, the mount block 40 may define a plurality of bores through which a plurality of motors shafts may extend. Moreover, the drive mechanism 26 may include a bearing disposed in the bore for supporting rotation of the motor shaft. The bearing may be a ball bearing, a roller bearing such as but not limited to a needle bearing, or a plain bearing, among other possibilities. It is to be appreciated that the drive mechanism 26 may include a plurality of bearings, each disposed in one bore defined by the mount block 40.

The plurality of electric motors 42 and the gears 50 may be each rotatable about a rotational axis. The rotational axes of the series of electric motors 42 may be aligned along a common plane. It is to be appreciated that this common plane moves with the drive mechanism 26 as the drive mechanism 26 moves with the second arm 20 and the third arm 22 of the scissor mechanism 16. Moreover, the output gear 52 may be rotatable about a rotational axis, and the rotational axis may be aligned along the common plane. However, it is to be appreciated that the rotational axis of the output gear 52 may be offset from the common plane.

The mount block 40 may be further defined as a first mount block 40, the plurality of electric motors 42 may be further defined as a first plurality of electric motors 42 defining a first initial electric motor 44, one or more first intermediate electric motors 46, and a first final electric motor 48. The drive mechanism 26 may further include a second mount block 54 extending along a second axis A2. The second axis A2 may extend parallel to the first axis A1. The drive mechanism 26 may also include a second plurality of electric motors 56 supported by the second mount block 54. The second plurality of electric motors 56 are arranged in series along the second axis A2 to define a second initial electric motor 58, one or more second intermediate electric motors 60, and a second final electric motor 62. The second mount block 54 may include all or some of the same characteristics of the first mount block 40, such as defining a plurality of bores and including a plurality of bearings each disposed in one bore of the second mount block 54.

The plurality of gears 50, the first plurality of electric motors 42, and the second plurality of electric motors 56 may be arranged in a plurality of drive assemblies 64. Each drive assembly 64 includes one of the first plurality of electric motors 42, one of the gears 50, and one of the second plurality of electric motors 56. The drive mechanism 26 may include at least three drive assemblies 64, at least four drive assemblies 64, at least five drive assemblies 64, at least six drive assemblies 64, at least seven drive assemblies 64, at least eight drive assemblies 64, at least nine drive assemblies 64, at least ten drive assemblies 64, or any other larger number of drive assemblies 64.

Moreover, the gear 50 of the first initial electric motor 44 may also be mounted to the second initial electric motor 58. In other words, there may be an initial drive assembly. Additionally, the gear 50 of the first final electric motor 48 may also be mounted to the second final electric motor 62. Thus, there may be a final drive assembly. The gear 50 of each of the one or more first intermediate electric motors 46 may also be mounted to one of the one or more second intermediate electric motors 60. As such, there may be one or more intermediate drive assemblies.

The first mount block 40 may be disposed between the first plurality of electric motors 42 and the gears 50, and the second mount block 54 may be disposed between the second plurality of electric motors 56 and the gears 50. The first plurality of electric motors 42 and the second plurality of electric motors 56 may be disposed opposite one another and configured to rotate in opposite rotational directions relative to one another. In other words, the first plurality of electric motors 42 may be configured to rotate clockwise and the second plurality of electric motors 56 may be configured to rotate counterclockwise, or the first plurality of electric motors 42 may be configured to rotate counterclockwise and the second plurality of electric motors 56 may be configured to rotate clockwise. In this manner, the total rotational torque imparted upon the gears 50 is additive of the torque generated by the first plurality of electric motors 42 and the torque generated by the second plurality of electric motors 56.

The one of the first plurality of electric motors 42 and the one of the second plurality of electric motors 56 in one drive assembly 64 may be considered to be in a parallel torque arrangement. Moreover, each drive assembly 64 may be arranged in a series torque arrangement. The electric motors 42 of the drive assemblies 64 arranged in series with one another need not rotate at the same rotational speed. It is contemplated that the electric motors 42 of the drive assemblies 64 arranged in series with one another may rotate at different rotational speeds. Additionally, the first plurality of electric motors 42 and the second plurality of electric motors 56 may be powered by alternating current or direct current. Sources of electrical energy (e.g., wires) to power the first plurality of electric motors 42 and the second plurality of electric motors 56 may be in electrical communication with a power source. It is to be appreciated that the sources of electrical energy (e.g., wires) may be of a coiled configuration able to expand and contract in length so as to continuously provide electrical energy to power the first plurality of electric motors 42 and the second plurality of electric motors 56 as the drive assembly 64 moves with the second arm 20 and the third arm 22 as the platform 14 is moved between the raised position and the lowered position.

As mentioned herein, the output gear 52 driven by the gear 50 of the final electric motor(s) 48, 62 receives the combined rotational torque from the gears 50 of the series of electric motors 42, 56. As such, the output gear 52 may be configured to receive rotational torque from the plurality of gears 50. The rotational torque provided to the output gear 52 may be exclusively provided by the gear 50 of the final electric motor 48. Moreover, each of the gears 50 may be sized such that a gear reduction is not established between the gears 50 of the series of electric motors 42, 56. Moreover, the output gear 52 may be sized such that a gear reduction is not established between the gear 50 of the final electric motor(s) 48, 62 and the output gear 52.

The drive mechanism 26 is designed to be low to the ground, and as such, may be referred to as a low-profile drive mechanism 26. As measured from the base 12 to the output gear 52, in non-limiting examples, the height of the drive mechanism 26 between the base 12 and the output gear 52 may be between about 5 inches and about 14 inches, may be between about 7 inches and about 12 inches, may be between about 8 inches and about 12 inches, may be between about 9 inches and about 11 inches, and may be about 10 inches. Depending upon end use, minimizing the height of the drive mechanism 26 may advantageously permit the drive mechanism 26 to operate in confined spaces, potentially generating a meaningful impact on performance of the drive mechanism 26.

The drive mechanism 26 may be configured to produce high torque at low rotations per minute (RPM) of the output shaft 66 and/or the gears 50. In a non-limiting example, the drive mechanism 26 may exert sufficient torque to lift thousands of pounds on the platform 14 between the lowered position and the raised position. The first plurality of electric motors 42, the second plurality of electric motors 56, and the gears 50 may be together configured to rotate the output shaft 66 between 1 RPM and 50 RPM, between 5 RPM and 40 RPM, between 10 RPM and 30 RPM, between 10 RPM and 20 RPM, and may be approximately 15 RPM. Such low rotations per minute of the output shaft 66 prevents binding of the gears 50, which may otherwise be expected from such an arrangement.

Moreover, the electric motors 42 arranged in spaced relation to one another along the axis A1 do not present any electric or magnetic field concerns that would prevent the electric motors 42 from successfully operating. More specifically, because the relative energy usage of each electric motor 42, 56 is relatively low, the total flux generated by the electric motor 42, 56 is insufficient to cause malfunction of adjacent electric motor(s) 42, 56. Therefore, the electric motors 42, 56 may be arranged in spaced relation to one another relatively closely along the axis A1. For example, a gap may be defined between adjacent electric motors 42, 56 along the axis A1. The gap may be between 0.1 inches and 3 inches, may be between 0.25 inches and 2 inches, may be between 0.25 inches and 1.5 inches, may be between 0.25 inches and 1.25 inches, and may be between 0.25 inches and 1 inch.

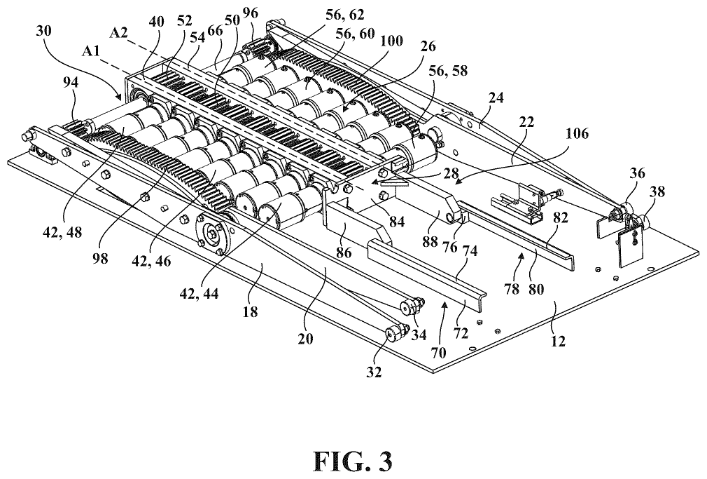

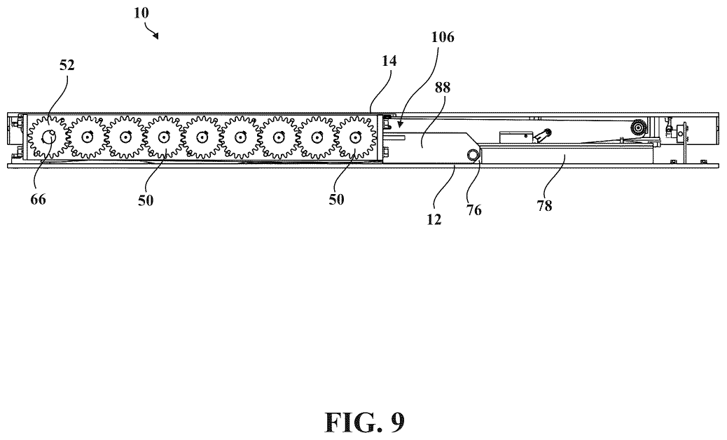

The first end 28 of the carriage 106 may include a slidable component 68. More specifically, the first end 28 of the carriage 106 includes a pivotable slidable component 68. The slidable component 68 is moveable (e.g., slidable) relative to the base 12 between a first slide position and a second slide position. The first slide position, as shown in FIGS. 1, 4, and 7, is associated with the raised position of the platform 14. The second slide position, as shown in FIGS. 3 and 9, is associated with the lowered position of the platform 14. The slidable component 68 may be a slidable block, a slidable wheel, or the like. The base 12 may include a track 70 to guide the slidable component 68 between the first slide position and the second slide position. The track 70 may include a slide wall 72 extending from the base 12 toward the platform 14 and a slide lip 74 extending such that the slidable component 8 is disposed between the slide lip 74 and the base 12. The slide wall 72 may assist the slidable component 68 in moving linearly. The slide lip 74 may prevent the slidable component 68 from disengaging from the base 12.

The slidable component 68 may be further defined as a first slidable component 68 and the first end 28 of the carriage 106 may further include a second slidable component 76. More specifically, the first end 28 of the carriage 106 may include a pivotable second slidable component 76. The second slidable component 76 is moveable relative to the base 12 between a first slide position and a second slide position. The second slidable component 76 may be a slidable block, a slidable wheel, or the like. The track 70 may be further defined as a first track 70 having a first slide wall 72 and a first slide lip 74, and the base 12 may include a second track 78 to guide the second slidable component 76 between the first slide position and the second slide position. The second track 78 may include a second slide wall 80 extending from the base 12 toward the platform 14 and a second slide lip 82 extending such that the second slidable component 76 is disposed between the second slide lip 82 and the base 12. The second slide wall 80 may assist the slidable component 68 in moving linearly. The second slide lip 82 may prevent the slidable component 68 from disengaging from the base 12.

The first end 28 of the carriage 106 preferably includes a support plate 84 fixed relative to the first mount block 40 and/or the second mount block 54. The first end 28 of the carriage 106 may further include a first support arm 86 fixed to the support plate 84 and pivotably coupled to the first slidable component 68. The first end 28 of the carriage 106 may also further include a second support arm 88 fixed to the support plate 84 and pivotably coupled to the second slidable component 76. In this way, the support plate 84, the first support arm 86, and the second support arm 88 permit the first end 28 of the carriage 106 to be fixed to the first slidable component 68 and to the second slidable component 76. In addition, the carriage 106 preferably includes a second support plate fixed relative to an opposing end of the first mount block 40 and/or the second mount block 54. As such, the multiple components of the carriage 106 and mount blocks 40, 54 of the drive mechanism move as a unit during the movement of the platform.

The drive mechanism 26 may further include an output shaft 66 rotationally fixed to the output gear 52. The output shaft 66 may be arranged to position the output gear 52 for engagement with the gear 50 of the final electric motor 48. The output shaft 66 may be keyed, or splined, to the output gear 52 to rotationally fix the output shaft 66 to the output gear 52. In other non-limiting examples, the output shaft 66 may be welded, brazed, soldered, or otherwise physically joined with the output gear 52, or the output shaft 66 may be formed integrally with the output gear 52 such as, but not limited to, by casting.

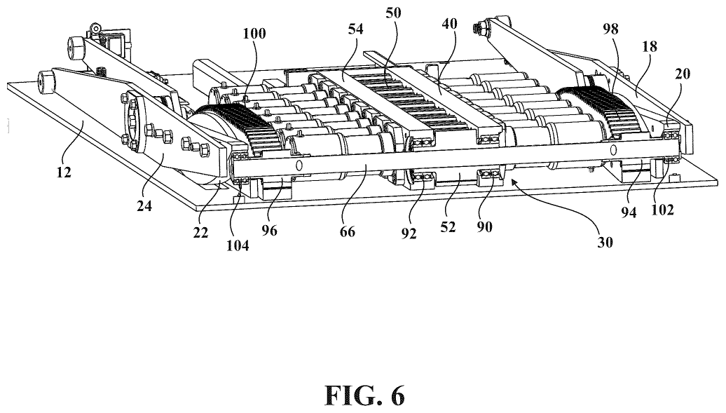

As shown in FIG. 6, the output shaft 66 may extend through a first bore in the first mount block 40 and may extend through a second bore in the second mount block 54. The lift assembly 10 may further include a first bearing 90 disposed in the first bore for supporting rotation of the output shaft 66 and a second bearing 92 disposed in the second bore for supporting rotation of the output shaft 66. The first bearing 90 and the second bearing 92 may be ball bearings, roller bearings such as but not limited to needle bearings, or plain bearings, among other possibilities.

The second end 30 of the carriage 106 may be moveable along the second arm 20 and the third arm 22 of the scissor mechanism 16 as the platform 14 moves between the raised position and the lowered position. The drive mechanism 26 may include a first pinion gear 94 rotationally fixed to the output shaft 66 and a second pinion gear 96 rotationally fixed to the output shaft 66. The first pinion gear 94 is engageable with the second arm 20 of the scissor mechanism 16 and the second pinion gear 96 is engageable with the third arm 22 of the scissor mechanism 16. More specifically, the second arm 20 of the scissor mechanism 16 may include a first plurality of teeth 98 engageable with the first pinion gear 94 and the third arm 22 of the scissor mechanism 16 may include a second plurality of teeth 100 engageable with the second pinion gear 96. The first plurality of teeth 98 may be arranged along the second arm 20 such that the first plurality of teeth 98 form a first rack along which the first pinion gear 94 is engageable, and the second plurality of teeth 100 may be arranged along the third arm 22 such that the second plurality of teeth 100 form a second rack along which the second pinion gear 96 is engageable. As can be seen in FIGS. 3-7, the first plurality of teeth 100 may be arranged to form a first cam surface along which the first pinion gear 94 may engage to assist in a smooth transition between the raised position and the lowered position. The second plurality of teeth 100 may also be arranged to form a second cam surface along which the second pinion gear 96 may engage to assist in a smooth transition between the raised position and the lowered position.

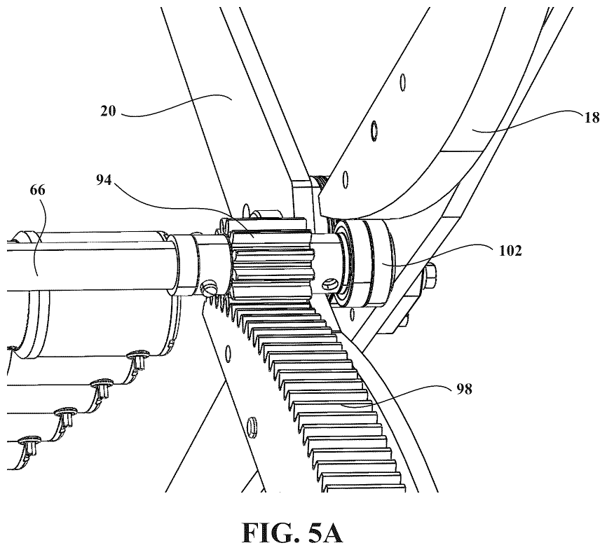

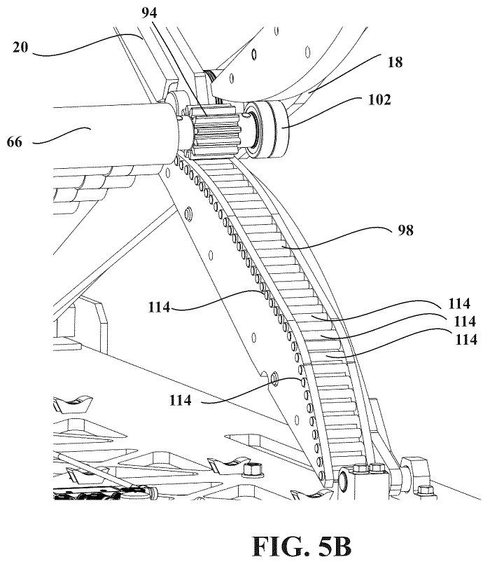

As seen in FIG. 5A, the first plurality of teeth 98 may be formed integrally with the second arm 20. In other words, the first plurality of teeth 98 may be integral with the second arm 20. Although not required, between 1 and 1.5 teeth of the plurality of teeth 98 may engage the first pinion gear 94 at any given time in the embodiment shown in FIG. 5A. It is to be appreciated that the second plurality of teeth 100 may be formed similarly as the first plurality of teeth 98 shown in FIG. 5A. As seen in FIG. 5B, the second arm 20 may define a plurality of bores through which a plurality of pins 114 are inserted. Each pin 114 may be fixed in each bore separately. The plurality of pins 114 act as the first plurality of teeth 98. Although not required, between 1.5 and 2 teeth of the plurality of teeth 98 may engage the first pinion gear 94 at any given time in the embodiment shown in FIG. 5B. As such, it is to be appreciated that torque may be transferred more easily in the embodiment shown in FIG. 5B. It is also to be appreciated that the length of the teeth of the first pinion gear 94 may be relatively longer, and the gap between adjacent teeth of the plurality of teeth 98 deeper, in the embodiment shown in FIG. 5B. It is to be appreciated that the second plurality of teeth 100 may be formed similarly as the first plurality of teeth 98 shown in FIG. 5B. Although FIG. 5B includes trademarks, the referenced components need not be the trademarked components referenced, and the reference to trademarks in FIG. 5B does not diminish the strength of the associated trademarks.

As can be seen in FIGS. 3-7, the first plurality of teeth 98 may include a first curved section proximal to the base 12, a second curved section distal to the base 12, and a straight section disposed between the first curved section and the second curved section. The straight section of the first plurality of teeth 98 is not curved. Instead, the straight section of the first plurality of teeth 98 may extend approximately parallel to the axis along which the second arm 20 extends. Similarly, the second plurality of teeth 100 may include a first curved section proximal to the base 12, a second curved section distal to the base 12, and a straight section disposed between the first curved section and the second curved section. The straight section of the second plurality of teeth 100 is not curved. Instead, the straight section of the second plurality of teeth 100 may extend approximately parallel to the axis along which the third arm 22 extends.

As discussed herein, in the illustrated embodiment, the combined rotational torque from the gears 50 of the series of electric motors 42 is used to drive the output gear 52. Thus, because the output gear 52 is rotationally fixed to the output shaft 66 and the first and second pinion gears 94, 96 are rotationally fixed to the output shaft 66, the combined rotational torque is also used to drive the output shaft 66, the first pinion gear 94, and the second pinion gear 96. It is to be appreciated that the output gear 52, the output shaft 66, the first pinion gear 94, and the second pinion gear 96 are all considered to be components of the second end 30 of the drive mechanism 26. Thus, through the engagement of the first pinion gear 94 with the first plurality of teeth 98 and engagement of the second pinion gear 96 with the second plurality of teeth 100, the combined rotational torque may be used to move the second end 30 of the drive mechanism 26 along the second arm 20 and the third arm 22 of the scissor mechanism 16 as the platform 14 moves between the raised position and the lowered position. As the second end 30 of the drive mechanism 26 is moved along the second arm 20 and the third arm 22, the first end 28 of the drive mechanism 26 may also be moved along the base 12 while being supported by the base 12. More specifically, as described herein, the first end 28 of the drive mechanism 26 may include the first slidable component 68 and the second slidable component 76 which are moveable between the first slide position and the second slide position. In this way, the combined rotational torque may also be used to move the first end 28 of the drive mechanism 26 along the base 12.

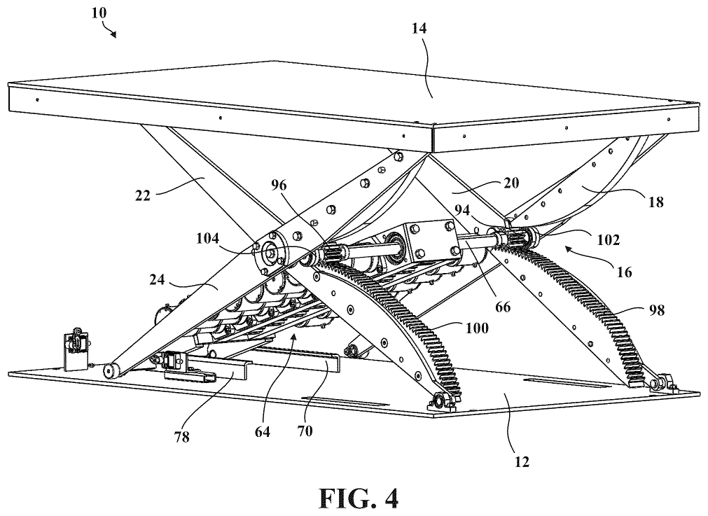

As shown in FIGS. 4-6, the drive mechanism 26 may further include a first guide bearing 102 engageable with the first arm 18 of the scissor mechanism 16 and a second guide bearing 104 engageable with the fourth arm 24 of the scissor mechanism 16. More specifically, the first arm 18 may be arranged to form respective cam surfaces along which the first guide bearing 102 and the second guide bearing 104 may travel along. The first guide bearing 102 and the second guide bearing 104 assist the platform to have a smooth transition between the raised position and the lowered position and limit misalignment of the first arm 18, the second arm 20, the third arm 22, and the fourth arm 24.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A lift assembly comprising:
a base;
a platform moveable relative to said base between a raised position and a lowered position;
a scissor mechanism coupled to said base and to said platform to move said platform relative to said base, with said scissor mechanism having a first arm, a second arm, a third arm, and a fourth arm each supported by said base and extending toward said platform;
wherein said first arm and said second arm are pivotable relative to one another to define a first pair of scissor arms to assist said platform in moving between said raised position and said lowered position,
wherein said third arm and said fourth arm are pivotable relative to one another to define a second pair of scissor arms to assist said platform in moving between said raised position and said lowered position; and
a drive mechanism disposed between said first and second pair of scissor arms to move said platform between said raised position and said lowered position;
wherein said drive mechanism includes a carriage coupled to said base such that said drive mechanism is moveable relative to said base with at least one of said first arm, said second arm, said third arm, and said fourth arm during said movement of said platform between said raised and lowered positions.

2. The lift assembly as set forth in claim 1, wherein said carriage extends between a first end supported by said base and a second end supported by said second arm.

3. The lift assembly as set forth in claim 2, wherein said second end of said carriage is further supported by said third arm of said scissor mechanism.

4. The lift assembly as set forth in claim 1, wherein said drive mechanism and said carriage pivots at an angle relative to said base as said platform moves between said raised position and said lowered position.

5. The lift assembly as set forth in claim 2, wherein said first end of said carriage includes a slideable component moveable relative to said base between a first slide position associated with said raised position of said platform and a second slide position associated with said lowered position of said platform.

6. The lift assembly as set forth in claim 5, wherein said base includes a track to guide said slideable component between said first slide position and a second slide position, with said track including a slide wall extending from said base toward said platform to assist said slideable component in moving linearly.

7. The lift assembly as set forth in claim 6, wherein said track further comprises a slide lip extending such that said slideable component is disposed between said slide lip and said base to prevent said slideable component from disengaging from said base.

8. The lift assembly as set forth in claim 5, wherein said drive mechanism further comprises a mount block extending along an axis, a plurality of electric motors supported by said mount block and arranged in series along said axis to define an initial electric motor, one or more intermediate electric motors, and a final electric motor, and wherein said carriage further comprises a support plate fixed relative to said mount block at said first end of said carriage and a support arm fixed to said support plate and pivotably coupled to said slideable component.

9. The lift assembly as set forth in claim 2, wherein said second end of said carriage is moveable along said second arm of said scissor mechanism as said platform moves between said raised position and said lowered position.

10. The lift assembly as set forth in claim 9, further comprising an output gear configured to receive a combined rotational torque from said drive mechanism, an output shaft rotationally fixed to said output gear, and a first pinion gear rotationally fixed to said output shaft, wherein said second arm of said scissor mechanism includes a plurality of teeth, and wherein said first pinion gear is engageable with said plurality of teeth of said second arm to assist in moving said second end of said carriage along said second arm of said scissor mechanism as said platform moves between said raised position and said lowered position.

11. The lift assembly as set forth in claim 10, wherein said plurality of teeth are arranged to form a cam surface along which said pinion gear may engage to assist said platform in moving between said raised position and said lowered position.

12. The lift assembly as set forth in claim 10, wherein said plurality of teeth are formed integrally with said second arm.

13. The lift assembly as set forth in claim 10, wherein said second arm defines a plurality of bores, and further comprising a plurality of pins each disposed in one of said plurality of bores to form said plurality of teeth.

14. The lift assembly as set forth in claim 10, wherein said plurality of teeth comprises a first curved section proximal to said base, a second curved section distal to said base, and a straight section disposed between said first curved section and said second curved section.

15. The lift assembly as set forth in claim 1, wherein said first arm is pivotably fixed to said platform and moveable relative to said base, wherein said second arm is pivotably fixed to said base and moveable relative to said platform, wherein said third arm is pivotably fixed to said base and moveable relative to said platform, and wherein said fourth arm is pivotably fixed to said platform and moveable relative to said base.

16. The lift assembly as set forth in claim 2, wherein said carriage of said drive mechanism extends along an axis between said first end and said second end, and wherein said drive mechanism further comprises a mount block extending along said axis, a plurality of electric motors supported by said mount block and arranged in series along said axis to define an initial electric motor, one or more intermediate electric motors, and a final electric motor.

17. The lift assembly as set forth in claim 16, wherein said drive mechanism further includes a plurality of gears, with each gear of said plurality of gears mounted to one of said plurality of electric motors.

18. The lift assembly as set forth in claim 17, wherein said plurality of gears are in meshed relation with one another.

19. The lift assembly as set forth in claim 17, wherein said drive mechanism further includes an output gear driven by said gear mounted to said final electric motor to receive said combined rotational torque from said gears of said series of electric motors.

20. The lift assembly as set forth in claim 17, wherein said plurality of electric motors and said plurality of gears are each rotatable about a rotational axis, and wherein said rotational axes of said series of electric motors are aligned along a common plane.

21. The lift assembly as set forth in claim 1, wherein said drive mechanism is free of a drive belt or a drive chain.
